(19) United States
(12) Patent Application Publication
(10) Pub. No.: US 2008/0271842 A1
(43) Pub. Date: Nov. 6, 2008

(54) Methods of Reducing Surface Checking on Wood Compositions

(75) Inventor: Martin R. Schoning, Clemmons, NC (US)

Correspondence Address: AKZO NOBEL INC., LEGAL & IP, 120 WHITE PLAINS ROAD, SUITE 300, TARRYTOWN, NY, 10591, US

(73) Assignee: Chemcraft International, Inc., Walkertown, NC (US)

(21) Appl. No.: 11/722,584

(22) PCT Filed: Jan. 26, 2006
(86) PCT No.: PCT/US06/02750

§ 371 Date: May 8, 2008

Related U.S. Application Data
(60) Provisional application No. 60/647,225, filed on Jan. 26, 2005.

(51) Int. Cl. B32B 37/02; B32B 38/10

(52) U.S. Cl. 156/275.5; 156/309.9; 156/153; 156/308.2

(57) ABSTRACT

A process is provided for producing a wood product exhibiting enhanced resistance to checking. The process comprises selecting a wood component, heating the surface of the wood component, and applying a radiation-curable composition to the surface.

### FIELD OF THE INVENTION

The invention relates to methods for reducing surface cracking on wood and wooden veneer surfaces and, more specifically, to methods and processes for making a coated wood product wherein the coated surface of the product has a reduced tendency to crack, or check, due to instabilities in the wood, stresses in the wood itself, and time. In particular, a method for reducing the surface cracking on wood and wooden veneer surfaces using infra-red heat treatment and/or a UV-cured primer/stabilizer treatment is provided.

### DESCRIPTION OF RELATED ART

Owing to the increasingly wide-spread utilization of forest resources and the accompanying scarcity of old-growth timber in many parts of the world, veneer coatings have become more commonplace. In fact, veneer coatings are used more and more in the commercial manufacture of numerous products as they serve to cover less attractive or less valuable products, such as various types of particle board, chip board, and similar “enhanced” wood composite products such as cabinets. Veneer is often used to cover tables, kitchen cabinets, shelving, doors, and flooring materials, as well as many musical instruments such as guitars, pianos, organs and violins. The use of veneers allows manufacturers to keep down the cost of making wood products, and in turn allows these products to be more affordable to the general consumer.

A commonly occurring and costly problem associated with the use of veneer in the manufacture of wood products, however, is the development of small cracks in the surface finish of the veneer, known as wood failures. These cracks are commonly referred to as “checks”, and typically appear as uniformly spaced hairline cracks either in the finish, or in severe cases, as cracks with accompanying ridges on the wood surface which can be detected by touch. In both cases, veneer checks typically run parallel with the grain of the wood, a characteristic useful in distinguishing veneer checks from other defects, such as random cracks due to non-wood-related causes or trauma to the veneer surface. Veneer checks are formed when stress failures occur in the face of the veneer, caused by differential shrinkage or swelling between the face veneer and the substrate to which it is applied. As the relative humidity of the environment in which the veneer panel is used changes, so does the moisture content of the panel. With wood, changes in moisture content result in shrinkage or swelling, typically during the “seasoning” period of processing; with veneer panels, when shrinking or swelling occur, the veneer does not “move” at the same rate as the substrate, thereby causing stresses within the panel which result in wood failure. Typical points at which checking occurs in veneer are in the weakest part of the wood which is generally over deep lathe checks or cracks, large pores, or other weakened areas of the face veneer. These failures in the face veneer overlaying a substrate create stress concentrations in the finish which result in the visible cracks, or veneer “checks”. If left untreated, checking can cause cracks in the coatings on the wood or wood veneer product.

While there are many factors which can contribute to the formation and severity of checks in wood and veneer surfaces, such as improper manufacturing practices, poor warehousing conditions, species of the face veneer, moisture content of the panel components in wood and wood products such as wood veneer products, the underlying dynamics behind cracking or “checking” is stress. Such stress can be more prevalent in wood veneers than in solid wood products, as veneers are typically manufactured by gluing thin slices of natural wood to an engineered wood product (e.g., plywood, MDF, or particleboard). These two materials react differently dimensionally to changes in moisture content, resulting in stressing of the surface and the occurrence of checking. Several approaches have been made in the art to address the checking problem in wood and wood veneers and to prevent or minimize checking in wood and wood veneer surfaces. For example, attempts have focused upon minimizing water contents in the glue mixture, using hot pressing versus cold pressing, lathe control, and temperature/humidity control during manufacturing. Other techniques have included using titanium, zirconium, and manganese compounds to provide wood surface protection to pine veneers.

Other approaches have been numerous and varied, and include (1) the use of surface reactive veneer finishing polymeric compositions as substitutes for standard wash coats and/or sealer coats in order to provide veneer finishes with an enhanced resistance to checking, (2) the use of UV-curable powder coatings, (3) and cutting stock material from a wood log using a rotary lathe blade and a nose bar arranged at the outer periphery of the stock material so as to control the thickness of the veneer to be cut and minimize the tendency to “check”.

Further approaches to the minimization of veneer checking have involved the use of polyethylene glycol (PEG). PEG reportedly can be used to treat wood veneers by replacing any water in the wood veneer with PEG, so that the passage of water in and out of the wood is no longer possible. Thus, checking due to humidity issues may be minimized under this approach. However, a limitation of these processes is that they tend to rely upon long soak times and are not often practical for commercial production.

Various prior solutions to the checking problems associated with wood and wood veneers are limited, however, in both their cost-effectiveness and ease of applicability into already existing veneer manufacturing processes. Thus, there exists a need for continuous methods for making and treating wood and veneer coated compositions, such that the wood and veneer coated compositions are not prone to cracking or checking. It would be further advantageous for the method to minimize the amount of time and materials necessary in order to deter wood and veneer checking.

### SUMMARY OF THE INVENTION

Processes for making a wood product enhanced in resistance to checking are described, as well as wood products prepared according such a process. These wood products exhibit a significant reduction in cracking, or “checking”, upon exposure to the ASTM standardized test.

Processes according to the present invention involve “de-stressing” the wood product surface by selecting a wood component having at least one major surface, subjecting at least one major surface of the wood component to heat applied from an infrared heat emitter or other suitable heat source for a period of time in order to raise the board surface temperature to a temperature greater than about 200° F., and applying a radiation-curable polymeric composition to the major surface of the wood component.

Processes described herein also include processes for producing a wood product having an exposed surface, or a wood veneer wherein, the wood or wood veneer has a reduced tendency to cracking or “checking”. The process comprises the steps of sanding the exposed surface of the wood or wood veneer with one or more abrasives, heating the exposed surface of the wood or wood veneer with an infrared heater (heat emitter) for a period of time sufficient to raise the board surface temperature to a temperature greater than about 200° F., and applying a radiation-curable polymeric composition to the exposed surface of the wood or wood veneer.

### DESCRIPTION OF THE FIGURES

The following figures form part of the present specification and are included to further demonstrate certain aspects of the present invention. The invention may be better understood, but not limited, by reference to one or more of these figures in combination with the detailed description of specific embodiments presented herein.

FIG. 1 illustrates a flowchart of a process according to one aspect of the present invention.

### DEFINITIONS

The following definitions are provided in order to aid those skilled in the art in understanding the detailed description of the present invention.

“Acrylate”, as used herein, is meant to include both acrylate and methacrylate species.

“Check”, or “checking”, as used herein, refers generally to a (typically) lengthwise separation of wood or a wood product, such as wood veneer, extending substantially parallel with the grain of the wood or across the annual growth rings.

“Wood-based composite panel”, as used herein, refers to structural or non-structural products formed from a variety of materials including wood and/or wood substrate products (e.g., flakes or strands of wood, as well as veneers of wood). These materials are optionally formed from moisture-containing substrates, permeable substrates, and substrates which are both moisture-containing and permeable. Suitable wood-based composite panels include, e.g., oriented strand board (OSB) and plywood.

“Flake”, as used herein, refers to a thin strand of wood that is produced from a flaker. In addition, as used herein, a “green flake” refers to a flake that has not been dried. The flake can have any suitable size, provided the flake can be effectively cured with a suitable resin. For example, the flake can typically have a length (y-dimension) of up to about 12 inches (30.4 cm) or about 4.5 inches (11.4 cm) to about 6.0 inches (15.2 cm) and can typically have a width (x-dimension) of up to about 12 inches (30.4 cm) or about 1.5 inches (3.8 cm) to about 2.5 inches (6.4 cm). Likewise, the flake can typically have a thickness (z-dimension) of about 0.001 inches (0.0025 cm) to about 0.10 inches (0.254 cm), about 0.010 inches (0.0254 cm) to about 0.060 inches (0.1524 cm), or about 0.020 inches (0.0508 cm) to about 0.030 inches (0.076 cm). Typically, the width of the flake will be a function of the length of the flake. The length of the flake is typically at least about three times greater than the width of the flake. This allows for proper flake orientation and an OSB with acceptable physical properties.

“Monomer”, as used herein, refers to any chemical species having at least one free radical polymerizable group (e.g., acrylate, methacrylate).

“Oriented Strand Board”, or “OSB”, as used herein, refers to an engineered structural-use panel typically manufactured from thin wood strands bonded together with resin under heat, pressure, and/or radiant energy. The strands are typically dried, blended with resin and wax, and formed into thick, loosely consolidated mats or blankets that are pressed under heat and pressure into large panels. The strands in the core layers are usually aligned perpendicular to the strand alignment of the face layers, like the cross-laminated veneers of plywood. It is appreciated that those of skill in the art understand that OSB is typically characterized by those starting materials or intermediate components useful in making the OSB, e.g., resin and flakes of wood. While these materials may undergo a substantial conversion during the manufacturing of the OSB, reference to OSB as including these materials or components is acceptable and appropriate to those of skill in the art. For example, each of the flakes of wood and the resin, during the pressing step (e.g., curing), can undergo a chemical and/or physical conversion such that they will no longer expressly and literally meet the criteria to be classified as a resin and a flake of wood. Reference to the OSB as including a resin and flakes of wood is, however, acceptable and appropriate to those of skill in the art. As such, as used herein, “oriented strand board” includes resin and flakes of wood.

“Plywood”, as used herein, refers to a laminate wood-based composite material manufactured from thin wood veneers (i.e., laminates) bonded together with resin under heat and pressure. It is appreciated that those of skill in the art understand that plywood is typically characterized by those starting materials or intermediate components useful in making the plywood, e.g., resin and veneers of wood. While these materials may undergo a substantial conversion during the manufacturing of the plywood, reference to the plywood as including these materials or components is acceptable and appropriate to those of skill in the art. For example, each of the veneers of wood and the resin, during the pressing step (e.g., curing), can undergo a chemical and/or physical conversion such that they will no longer expressly meet the criteria to be classified as a resin and a veneer of wood. Reference to the plywood as including a resin and veneers of wood, however, is acceptable and appropriate to those of skill in the art. As such, as used herein, “plywood” includes resin and veneers of wood.

“Surface”, as used herein, refers to the outermost boundary of a substrate (e.g., solid wood, flake, veneer, OSB, or plywood). The surface includes the top surface, the bottom surface and optionally the side surfaces.

“Elevated board surface temperature”, or “elevated BST” as used herein, refers to any temperature above a board surface temperature of about 200° F. (about 93.3° C.). Typically, and in accordance with the present invention, elevated BST refers to temperatures above about 210° F. (about 98.9° C.) up to about 400° F. (about 204.4° C.), and more preferably between about 225° F. (about 107.2° C.) and about 350° F. (176.7° C.). Most preferably, and in accordance with the present invention, elevated board surface temperature refers to board surface temperatures between about 250° F. (121.1° C.) and about 325° F. (162.8° C.).

“Ultraviolet radiation” and “UV radiation” are used interchangeably herein to refer to the spectrum of light comprising wavelengths within the range from about 180 nm to about 400 nm, including UV A radiation (320 nm to 400 nm), UV B radiation (290 nm to 320 nm), and UV C radiation (<290 nm).

“Veneer”, as used herein, refers to a very thin layer of wood sliced or peeled from a hardwood or softwood log, including sawn veneers, having minimal imperfections such as knots and decay, and used to cover a less desirable product so as to provide a more attractive surface.

### DETAILED DESCRIPTION OF THE INVENTION

The present invention is directed to processes to reduce surface cracking or checking on wood product surfaces. The process generally can involve the de-stressing of the wood product surface using infrared heat energy (such as that from an infrared heat emitter), followed by the application of a radiation-curable polymeric composition in order to simultaneously stabilize the wood veneer surface as well as prime the surface of the veneer for application of further paint or stain coatings. The de-stressing process using infrared heat energy, or other suitable heat source, can occur at any number of places during the final processing of the wood product, including before the final sanding process to the wood product but before the application of a radiation-curable polymeric composition, or after the final sanding process but prior to the application of a radiation-curable polymeric composition.

As used herein, wood products include solid woods, such as solid hardwood floors and boards; wood veneers, such as any number of loose-cut or tight-cut veneer products laminated or otherwise attached to a “core”, such as a solid wood core, plywood cores, particle board cores, MDF cores, flake core boards, chipboard cores, and similar engineered core materials; furniture, such as desks, chairs, beds, and the likes; cabinets; and musical instruments, including violins, violas, cellos, guitars, mandolins, and the like. Preferably, the wood product is a solid hardwood such as wood flooring, or a wood veneer attached to a core material.

In an embodiment of the present invention, a process for producing a wood product exhibiting enhanced resistance to checking is described, wherein the process comprises selecting a wood component having at least one major surface, heating the surface of the wood component for a specific period of time (dwell time) using an infrared or other suitable heat source such that the board surface reaches a temperature of at least about 200° F., and applying a radiation-curable composition to the surface of the wood component. The heating of the surface of the wood component can occur prior to the application of the radiation-curable composition. While a board surface temperature of at least about 200° F. is preferred to achieved optimum results, for this embodiment and the embodiments that follow, a board surface temperature of less than about 200° F. will yield the desired results for some applications, depending upon the thickness of the wood or wood veneer, the type of wood or wood veneer, or other processing variables. The wood component can be a solid wood component such as solid wood flooring, furniture, or a cabinet.

In another embodiment of the present invention, a process for reducing surface cracking in a wood veneer surface is described, wherein the process comprises sanding an exposed surface of the wood veneer with one or more coated abrasives, subjecting the wood veneer surface to heat applied from an infrared or other suitable heat source for a dwell time sufficient to raise the board surface temperature to about 200° F., and applying a radiation-curable composition to the exposed surface of the veneer. The heating step can be applied before the sanding step and the application of the radiation-curable composition. The heating step and the application of the radiation-curable composition can occur before the sanding step. Alternatively, the heating step can occur after the sanding step but before the application of the radiation-curable composition.

In yet another embodiment of the present invention, a process for reducing surface cracking in the ends of wood products is described, wherein the process comprises subjecting the end of the wood product to heat applied from an infrared or other suitable heat source for a dwell time sufficient to raise the board surface temperature to about 200° F., and applying a radiation-curable composition to the exposed end surface of the wood product. An optional sanding step can be included in this process. The heating step can be applied before a sanding step and the application of the radiation-curable composition. Alternately, the heating step and the application of the radiation-curable composition can occur before a sanding step. Alternatively, the heating step can occur after the sanding step but before the application of the radiation-curable composition.

While compositions and methods are described in terms of “comprising” various components or steps, the compositions and methods can also alternatively “consist essentially of” or “consist of” the various components and steps.

The production of wood products begins with harvesting of timber and milling and/or machining the timber into the desired wood product. Such processes include machining processes known to those of skill in the art, such as those described for example in U.S. Pat. No. 5,652,065. Typically, such processes include cutting, lathing, and a number of sandings using a variety of grit combinations, including 60/80/100/120/150/180/240 and 280 combinations. A preferred initial sanding sequence prior to the finishing processes of the present invention includes 80/100/120 and 150 grit sequential sandings of the wood product surface using a sanding machine. Following sanding, the wood product enters the finishing stage, which typically includes stain application, sealing, and/or topcoat application.

The following general description of a process in accordance with the present invention is given for the manufacture of a wood veneer product with a surface resistant to checking. However, it will be apparent to those of skill in the art that variations in this process, such as the order and placement of the various steps and the type of wood material used, can be executed while still obtaining the same end result. Such variations are included within the scope of the present invention.

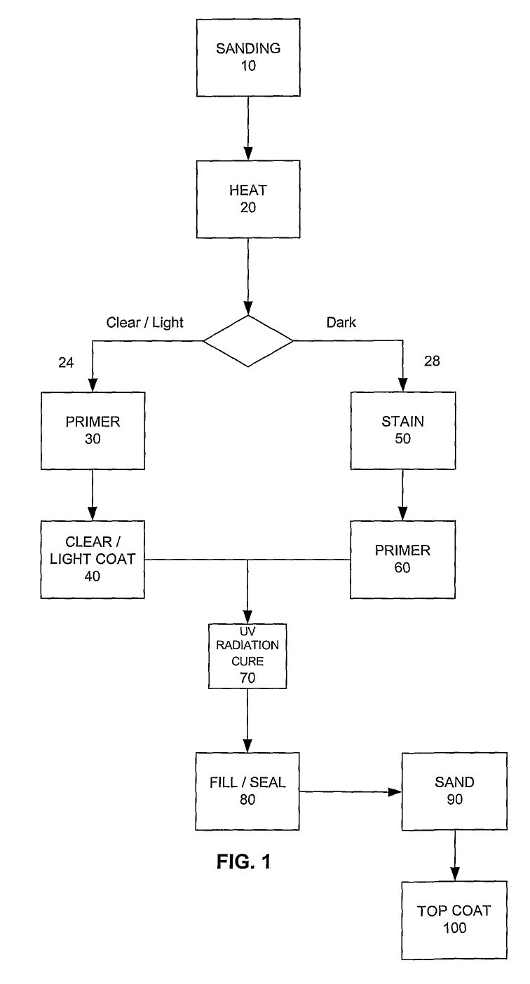

As shown in FIG. 1, and in accordance with an embodiment of the present invention, the wood product enters the finishing stage and undergoes an optional wood sanding sequence 10. In this step, the surface of the wood veneer is sanded with one or more sanding grits (e.g., sandpapers) having grits from about 60 grit to about 180 grit, using a multi-head or other suitable sanding apparatus. Such coated abrasives are typically classified as “fine” by both the Coated Adhesives Manufacturer's Institute (CAMI) and the Federation of European Producers of Abrasives (FEPA). Such sanding grits (or coated abrasives) will, in accordance with the present invention, have average particle sizes from about 125 microns to about 82 microns, and more preferably from about 93 microns to about 78 microns.

Following the sanding sequence 10, in one embodiment the wood can be subjected to infrared preheating process 20, wherein heat is applied from a heat source to the surface of the wood veneer for a period of time. Preferably, the wood veneer is exposed to an infrared heat source emitting from about 100 W per inch to about 200 W per inch output of the lamp for a period of time, the dwell time (DT), of from about 1 second to about 20 seconds, and more preferably from about 5 seconds to about 10 seconds. Dwell times suitable within the present invention preferably include about 2 seconds, about 3 seconds, about 4 seconds, about 5 seconds, about 6 seconds, about 7 seconds, about 8 seconds, about 9 seconds, about 10 seconds, about 12 seconds, about 14 seconds, about 16 seconds, about 18 seconds and about 20 seconds, as well as dwell times between any two of these time ranges, such as from about 5 seconds to about 9 seconds. Exposure of the wood veneer surface to a heat source for such a dwell time can raise the board surface temperature (BST) to above about 200° F., preferably to a BST of between about 210° F. to about 400° F., and more preferably to a BST of between about 250° F. to about 325° F. During step 20 of the process, the wood veneer surface can be typically traveling about 20 linear fpm (feet per minute) to about 80 linear feet per minute.

As used herein, dwell time (DT) refers to the time that a section of the wood or wood product's surface spends under the energy source (e.g., an infrared emitter). More particularly, dwell time refers to the time, t₀, when the board surface enters the infrared heated area to that time, t_{f}, when the board surface exits the heated area under the infrared or other heat emitter. Boards surface temperature (BST), as used herein, is the temperature of a board surface measured at about 3 to about 4 inches downstream from the final heat emitter along the wood traveling path. Typically, and in accordance with the present invention, the board surface temperature (BST) can be measured using any appropriate means or apparatus, including infrared (IR) heat sensor guns or similar gauges such as the Raytek MT-4, MX-2, or MX-4 (Fluke Corp., Everett, Wash.), or thermocouples placed on or just under the surface of the wood.

In accordance with the present invention, infrared heat sources suitable for use in the processes of the present invention include halogen infrared emitters, carbon medium infrared emitters, and high power carbon medium infrared emitters, and any suitable infrared emitters known in the art which give off electromagnetic radiation, which is then converted into heat in the product. Suitable infrared heat sources include any which emit in the near infrared region (about 0.7-1.0 m), mid-infrared region (about 3-5 m), and long infrared region (about 8-12 m), and most preferably those infrared heat sources which emit in the thermal infrared wavelengths (e.g., from about 3 m to about 12 m). Infrared heat sources suitable for use with the present invention preferably operate in the range of about 9000 W of power for a 52-inch wide conveyor, at about 480 V, and provide about 173 W/in output, such as those carbon medium emitters sold by Heraeus Noblelight, Inc. (Duluth, Ga.). Typically, the infrared heat sources are mounted from about 3 inches to about 6 inches above the conveyor which transports the wood or wood products, with a typical spacing of about 3 to about 6 inches lamp-to-lamp (i.e., there can be about 3 inches of space between each of the infrared heat sources). Those of skill in the art will understand that the wattage of the lamp will depend upon the width of the conveyor and the desired board temperature to be obtained, and the number of infrared lamps will depend upon a combination of both the wattage of the infrared lamp and the line speed of the finishing conveyor system. For example, when using a 9000 W infrared lamp for a 52-inch wide conveyor, about 12 infrared lamps could be used for line speeds of about 20 ft/min (feet per minute) to about 35 ft/min in order to obtain a dwell time of about 5 to about 10 seconds and a BST of about 250 to about 325° F.; similarly, for a line speed of about 40 ft/min to about 60 ft/min, about 20 infrared lamps may be needed to obtain dwell times and BSTs in accordance with the present invention.

Following the infrared preheat step 20, two separate pathways can be taken as shown in FIG. 1, depending upon whether the final veneer wood product will have a clear or light color 24, or if the final veneer wood product will have a darker color 28. In the event that the wood veneer product is to have a clear or light stain applied, following step 20 the veneer is subjected to a radiation-curable primer application 30. The primer application 30 can comprise the application of an acrylate-based polymer composition at a rate of about 1.0 to about 4.0 grams per ft², and more preferably at a rate from about 1.1 g/ft² to about 2.0 g/ft², and all rates in between such values, e.g., from about 1.2 g/ft² to about 1.8 g/ft². The acrylate-based polymer can be a polymer composition having reactive groups which are capable of being initiated with photoinitators and UV light, thereby making it a radiation-curable primer. Additional information of such a polymeric composition are described below. Radiation-curable primer application 30 is followed by the application of the clear or light coat in application step 40. Following application of the clear or light coat in step 40, the radiation curable primer and clear or light coat are subjected to a UV radiation source, as described in greater detail below, to cure 70 the radiation curable primer. This is followed by filling and/or sealing of the wood with clear coats in sealing step 80. Alternatively, the clear or light coat may be combined with the primer in step 30.

In the alternative, and equally acceptable instance that the final wood veneer product will have a darker color (e.g., cherry or black walnut), following infrared preheat step 20 the veneer can be subjected to a stain application step 50. Following application of the appropriate stain, the wood veneer surface can be treated to primer application 60, comprising the application of an acrylate-based polymer composition at a rate of about 1.0 g/ft² to about 4.0 g/ft², as detailed above. Following primer application step 60, the radiation-curable primer is subjected to a UV radiation source, as described in greater detail below, to cure 70 the radiation-curable primer. Next, the wood veneer product can be filled and/or sealed and additional clear coats are applied in sealing step 80.

As illustrated in FIG. 1, after filling/sealing step 80, the pre-stressed wood veneer product, now having a resistance to wood cracking, or “checking”, may undergo a further sanding in sanding step 90 in order to prepare the sealers on the surface of the veneer for a final topcoat application 100. Following completion of sanding step 90, the wood veneer surface undergoes topcoat application 100, in order to achieve the final appearance (e.g., sheen, physical properties, etc.) of the wood veneer product. Alternatively, the radiation curable primer (steps 30 or 60 of FIG. 1) can be applied prior to the heat step 20, and even prior to the sanding step 10.

The veneer wood product, in accordance with an embodiment of the present invention, can be any thickness between about 1/100 inch and about ¼ inch, but it is more preferably of a thickness between about 1/100 inch and about ⅛ inch. More preferably, the veneer is between about 1/16 and about 1/42 inch (0.6 mm) in thickness, and most preferably between about ⅙ inch and about 1/25 inch. The veneer can also be made of any suitable type or species of timber/wood, as described below.

Any suitable species of timber (i.e., wood) can be employed to make the wood products, wood veneer, wood core, or combination thereof suitable for inclusion in the present invention. Suitable types of timber include but are not limited to Western timber, Northern (and Appalachian) timber, and Southern timber. Preferably, the veneer is made from Northern timber, such as Black Cherry, Red Oak (such as Southern Red Oak), Black Walnut, Sugar Maple, or Tulip Poplar.

Suitable Western timbers include Incense-Cedar, Port-Orford-Cedar, Douglas Fir, White Fir, Western Hemlock, Western Larch, Lodgepole Pine, Ponderosa Pine, Sugar Pine, Western White Pine, Western Redcedar, Redwood, Engelmann Spruce, Sitka Spruce, Yellow-Cedar, Red Alder, Oregon Ash, Aspen, Black Cottonwood, California Black Oak, Oregon White Oak, Big Leaf Maple, Paper Birch, and Tanoak.

Suitable Northern (and Appalachian) timbers include, e.g., Northern White Cedar, Balsam Fir, Eastern Hemlock, Fraser Fir, Jack Pine, Red Pine, Eastern White Pine, Eastern Red Cedar, Eastern Spruce, Tamarack, Ash, Aspen, Basswood, Buckeye, Butternut, American Beech, Birch, Black Cherry, American Chestnut, Cottonwood, Elm, Hack Berry, True Hickory, Honey Locust, Black Locust, Hard maple, Soft Maple, Sugar Maple, Red Oak, White Oak, American Sycamore, Black Walnut, and Yellow-Poplar (Tulip Poplar).

Suitable Southern timbers include, e.g., Atlantic White Cedar, Bald Cypress, Fraser Fir, Southern Pine, Eastern Red Cedar, Ash, Basswood, Arnecan, Beech, Butternut, Cottonwood, Elm, Hackberry, Pecan Hickory, True Hickory, Honey Locust, Black Locust, Magnolia, Soft Maple, Red Oaks, Sassafras, Sweetgum, American Sycamore, Tupelo, Black Walnut, Black Willow, and Yellow Poplar.

In certain embodiments of the present invention, the wood product is a wood veneer which can substantially cover a solid wood surface or core, a composite wood core or surface, or a combination of both. In one aspect of the present invention, the wood veneer substantially covers a composite wood core or surface.

The composite wood core can have virtually any number of plys, but typically has between 1 and 20 plys, more typically, 1, 3, 5, 7 or 9 plys. The plys are typically a relatively inexpensive, but advantageously dimensionally stable, wood such as poplar. In the industry, plywood is typically available in a variety of thicknesses, ranging from ⅛ to 1 inch, and is more typically ⅜, ½ or ¾ inch material. The thickness is generally determined by the number of individual plys, including the outer veneer layer or layers. Examples of such composite wood cores having a number of individual plys are plywoods.

Sources for suitable plywood include those manufactured by Georgia-Pacific (Atlanta, Ga.), Boise-Cascade (Boise, Id.), Norbord Industries (Toronto, Canada), Willamette Industries (Portland, Oreg.), Roseburg Forest Products (Roseburg, Oreg.), Louisiana-Pacific (Nashville, Tenn.), Weyerhaeuser (Federal Way, Wash.), Hood Industries (Hattiesburg, Miss.), Plum Creek (Seattle, Wash.), or Hunt Forest Products, Inc. (Ruston, La.).

In some embodiments, it is not necessary to have a decorative veneer on both sides. This is particularly true when one face is never seen, for example, in flooring operations where one face is seen and the other is attached to or at least placed over a sub-floor. However, veneer flooring often includes veneer on both faces so that the best match between adjacent flooring strips can be obtained.

In some embodiments, the veneer is not applied to a plywood core, but rather, to a particle board, medium density fiberboard (MDF), flake, chipboard, solid wood or other suitable core. The veneer can be applied in any of the methods known in the art, including but not limited to gluing and laminating.

Coating compositions, in accordance with the present invention, can be applied to the surface (or surfaces) of the wood products using any number of methods known to those of skill in the art. Such methods include roller coating, spray coating, vacuum coating, electrodeposition coating, and the like. Preferably, the compositions are applied using roller coating, including those machines having both upper and lower roller coaters such as described in U.S. Pat. No. 6,821,345 and differential roll coaters, spray coating, or combinations thereof. In the instance of roll coating, a differential (or other suitable) roll coater applies the coating composition to the substrate (e.g., surface of the wood product) via a rotational roll covered with an elastomeric compound. The roll contacts the substrate and in doing so transfers the coating to the substrate. Coating rates suitable for use in accordance with the present invention are from about 5 g/m² (0.45 g/ft²) to about 50 g/m² (4.5 g/ft²), and more preferably from about 10 g/m² (0.9 g/ft²) to about 25 g/m² (2.7 g/ft²), as well as rates between these two values (e.g., from about 10 g/m² (0.9 g/ft²) to about 20 g/m² (1.8 g/ft²)).

A radiation-curable polymeric composition can be used to prime and stabilize the veneer, as shown in steps 30 and/or 60 in FIG. 1. The radiation-curable polymeric composition, as used herein, includes primers such as acrylic polymeric compositions comprising one or more reactive monomers; lacquers such as nitrocellulose lacquers and 2- or multi-component lacquers; pre-catalyzed reactive amino coatings; wash coats and/or sealer coat compositions; post-catalyzed reactive amino coatings; vinyl coatings and finishes; polyester and polyester-based coatings; polyurethanes; UV-coatings and UV-curable finishes, such as stains and/or paints; varnishes; stains; paints and/or coloring agents; and light stable finishes, as well as combinations thereof. Such radiation-curable polymeric compositions include one or more initiators, including both thermoinitiators and photoinitiators. Preferably, the radiation-curable polymeric compositions are acrylic polymeric compositions comprising acrylate-based monomers and/or oligomers with reactive groups that can be initiated with any number of initiators, including but not limited to photoinitiators, cationic initiators, anionic initiators, oligomeric initiators, and thermal initiators. Preferably, the initiators are photoinitiators or thermal initiators. In accordance with the present invention, a radiation-curable polymeric composition preferable for use is Opticure® CHEMFLEX™ L332203 (Chemcraft International, Inc., Winston-Salem, N.C.), a 100% (wt. %) solids, acylate-based polymeric composition comprising initiators and isocyanate functional groups with <0.01 lb Volatile Organic Compounds (VOC) per gallon and <0.01 lb/gallon of volatile hazardous air pollutants (VHAPs); however, other suitable radiation-curable compositions may be used.

The radiation-curable polymeric compositions suitable for use within the present invention preferably have a high (i.e., greater than about 50 wt. %) percent of solids by weight and/or by volume. Preferably the radiation-curable polymeric compositions have greater than about 50 wt. % solids, more preferably greater than about 70 wt. % solids, and most preferably greater than about 90 wt. % solids. For example, radiation-curable polymeric compositions suitable for use within the present invention can have about 50 wt. %, about 55 wt. %, about 60 wt. %, about 65 wt. %, about 70 wt. %, about 72 wt. %, about 74 wt. %, about 78 wt. %, about 80 wt. %, about 82 wt. %, about 84 wt. %, about 86 wt. %, about 88 wt. %, about 90 wt. %, about 92 wt. %, about 94 wt. %, about 96 wt. %, about 98 wt. %, and about 100 wt. % solids, as well as any weight percent solids value between any two of these values, i.e. from about 50 wt. % to about 100 wt. %, or from about 90 wt. % to about 100 wt. % solids.

The radiation-curable polymeric compositions suitable for use with UV radiation curing (step 70 FIG. 1) can cure with any type of ultraviolet radiation, including UV A radiation (radiation from 320 nm to 400 nm), UV B radiation (radiation from 290 nm to 320 nm), UV C radiation (radiation <290 nm), or UV V radiation (radiation from 400 nm to 420 nm). Preferably, the compositions of the present invention are cured with UV A radiation using an appropriate UV curing lamp (i.e., one having from about 200 to about 400 millijoules of UVA energy) at a wavelength from about 320 nm to about 400 nm, and more preferably from about 350 nm to about 400 nm.

In accordance with the present invention, the above radiation-curable polymer composition can further comprise an initiator or combination of initiators which, when activated (e.g., thermally or by irradiation) form free radicals and thereby catalyze or accelerate the cure rate of the composition, and/or serve to initiate the curing of the composition. Such initiators can be thermal initiators, photoinitiators, or combinations thereof. Initiators (e.g., photoinitiators) can be added in effective mounts, i.e. in amounts of about 0.1% to about 10% by weight, based on the total amount of the radiation-curable polymer composition. More preferably, the amount of initiator is from about 1 wt. % to about 10 wt. %, including about 2 wt. %, about 3 wt. %, about 4 wt. %, about 5 wt. %, about 6 wt. %, about 7 wt. %, about 8 wt. %, and about 9 wt. %, as well as values between any two of these values, e.g., about 4.5 wt.

Thermal initiators suitable for use with the present invention include known thermal initiators such as azo-bisisobutyronitrile (AIBN) or peroxides including benzoyl peroxide, dicumyl peroxide, tert-butyl hydroperoxide, and tert-butyl perbenzoate, all of which can be obtained from a variety of commercial sources. Such thermal initiators, when used, are present in an amount sufficient to at least partially cure the radiation curable polymeric composition, e.g., in amounts from about 0.1 wt. % to about 10 wt. % based on the total amount of the composition.

The novel compositions of the present invention can also contain other photoinitiators of different sensitivity to radiation of emission lines of different wavelengths. The inclusion of such photoinitiators effects the better utilization of a UV/VIS light source which radiates emission lines of different wavelength. It is advantageous to choose these other photoinitiators and to use them such that a uniform optical absorption is produced with respect to the emission lines used.

Photoinitiators include all of those initiators that are capable of catalyzing or accelerating cure rates by exposure to ultraviolet radiation, including ultraviolet, x-ray, and infrared radiation. Photoinitiators suitable for use with compositions of the present invention include but are not limited to benzophenones, such as benzophenone, 2-chlorobenzophenone, 4-methoxybenzophenone, 2,2′,4,4′-tetrachlorobenzophenone, 2-chloro-4′-methylbenzophenone, 4-chloro-4′-methylbenzophenone, 3-methylbenzophenone, 4-tert-butylbenzophenone, and 4,4′-bis(N,N′-dimethylamino)benzophenone; benzoins and benzoin ethers, including benzoin, benzoin acetate, benzoin methyl ether, benzoin ethyl ether, Michler's ketone, benzoin butyl ether, benzoin isopropyl ether, and benzoin phenyl ether; acetophenones, including acetophenone, diethoxyacetophenone, the 2-, 3- and 4-methylacetophenones and methoxy-acetophenones, 2,2-dimethoxyacetophenone, 2,2-diethoxyacetophenone, 2,2′-dimethoxy-2-phenylacetophenone, 3- and 4-allyl-acetophenone, and 1,1-dichloroacetophenone; benzyl and benzyl ketals, such as benzyl dimethyl ketal and benzyl diethyl ketal; anthraquinones, including anthraquinone, 2-methylanthraquinone, 2-ethylanthraquinone, 2-tert-butylanthraquinone, 9,10-phenanthrenequinone, 1-tert-butylanthraquinone, 1,4-naphthaquinone, 1-chloroanthraquinone, and 2-amylanthraquinone; triphenylphosphine; benzoylphosphine oxides, such as 2,4,6-trimethylbenzoyldiphenylphosphine oxide (Luzirin TPO); xanthones and thioxanthones, such as the 2- and 3-chloroxanthones and chlorothioxanthones, isopropylthioxanthone, 2-isopropylthioxanthone, 2-methylthioxanthone, decylthioxanthone, 2-dodecylthioxanthone, and 3-chloro-2-nonylxanthone; acridine derivatives; phenazine derivatives; quinoxaline derivatives; 1-aminophenyl ketones or 1-hydroxyphenyl ketones, such as 1-hydroxycyclohexyl phenyl ketone, phenyl 1-hydroxyisopropyl ketone, and 4-isopropylphenyl 1-hydroxyisopropyl ketone; propiophenone; fluorenone; carbazole; methyl blue; 2-acetyl-4-methylphenyl acetate; benzaldehyde; fluorine; triphenylamine; p-diacetylbenzene; isobutyl ether-benzoic acetate, benzyl; benzilic acid; amino benzoate; 2-2-methyl-1, [4-(methylthio)phenyl]-2-morpholinopropanone-1; combinations thereof and the like. As recited previously, the optional photoinitiator or combination of photoinitiators is typically used in an amount ranging from about 1 wt. % to about 10 wt. % by weight of the composition.

Additional, optional components can be included within the radiation-curable compositions suitable for use within the present invention. Such additional components include, but are not limited to, additives such as wetting agents, fillers, inhibitors, pesticides, fungicides, flame retarders, and antiaging agents. These optional components comprise from about 0% to about 5% by weight of the radiation-curable polymer composition.

Wetting agents can be added to the coatable compositions of the present invention in minor amounts (e.g., less than 5 wt. %) in order to facilitate uniform coating over the veneer. Suitable wetting agents include, for example, anionic or nonionic agents, such as Alkanol® (DuPont, Wilmington, Del.); electroneutral wetting agents; amphoteric wetting agents; non-ionic wetting agents; and fluorinated wetting agents such as those commercially available under the trade designations FLUORAD FC-431™ and FLUORAD FC-171™, both available from Minnesota Mining and Manufacturing Company (St. Paul, Minn.).

Fillers can be added to the coatable, radiation-curable compositions of the present invention in order to modify wear properties, such as the modulus of elasticity, heat distortion stability, and the thermal expansion coefficient. Fillers suitable for use in compositions of the present invention include those silica-based fillers known to be useful in acrylate clear coat applications, such as silica particles modified with 3-mercaptopropyltrimethoxysilane; organic fillers such as wood, straw, and annual vegetation; silicates; silica; carbonates; carbon black; hydrated alumina; mineral fillers, such as clays (e.g. bentonite); and organic fillers such as synthetic organic polymers (e.g., PHD polyols).

Inhibitor/stabilizers can be used as a component of the coatable compositions described herein. As the presence of oxygen will inhibit the rate of the cure due to oxygen's very strong inhibition rates, such inhibitor compounds can be included to circumvent this problem. Suitable inhibitors include NPHA, NPAL, and ST blends from Albemarle (Baton Rouge, La.). The inhibitor can be present in the radiation-curable compositions in an amount constituting from about 0.1 wt % to about 10 wt %, and more preferably from about 1 wt % to about 5 wt %, of the composition.

Pesticides, fungicides, or combinations thereof can also be included in the coatable compositions of the present invention. Any suitable pesticide (e.g., insecticide), fungicide, or combination thereof can be employed provided they retain their effectiveness (e.g., termite resistant properties or antifungal properties) during the manufacturing and curing process, that the coatable compositions of the present invention remains stable during the manufacture of the veneer coated product, and that each retains their effectiveness over extended periods of time typically encountered with the lifespan of the wood based composite panel (e.g., up to about 25 years, or up to about 50 years).

The fungicide and/or pesticide can be any chemical that has been approved by the relevant controlling government agency, e.g., the Environmental Protection Agency (EPA) or the Food and Drug Administration (FDA), the Federal Insecticide, Fungicide, and the Rodenticide Act (FIFRA) of the Federal Environmental Pesticide Control Act (FEPCA) of 1972. Suitable fungicides for inclusion in the coatable compositions described herein can include formic acid, acetic acid, propionic acid, pelargonic acid, capric acid, copper ammonium acetate (CAA) such as that available as COMPTEC SOLUTION™ (Chemical Specialties, Inc., Charlotte, N.C.), copper naphthenate, or combinations thereof. Pesticides suitable for inclusion in the coatable compositions of the present invention include those which are copper-containing, such as copper ammonium carbonate (CAC) or any of the known insecticides which are useful for the mitigation, control, or elimination of insect species of the order Isoptera(e.g., white ants or termites).

Flame retardants can be added to the coatable compositions of the present invention in order to minimize the flammability of the composition. Suitable flame retardants include but are not limited to halogenated flame retardants (organic bromine compounds, such as dibromopropanol); phosphorus compounds (e.g., polymeric phosphate); nitrogen compounds; aluminum hydroxide; and combinations thereof, including combinations containing synergists to increase the retardant activity. Flame retardants can be non-reactive, such as (oligomeric) chloralkyl phosphonates, dimethylmethylphosphonate, polymeric phosphate, bromine-phosphorus compounds, organic bromine compounds, or ammoniumpolyphosphate; alternatively, the flame retardants can be reactive flame retardants, such as diethyl-bis-hydroxyethyl-aminoethyl-phosphate, neopentylbromide-polyether, neopentylbromide-adipate, trichlorobutyleneoxide-polyether, dibromopropanol, dibromoneopentylglycol, trans-2,3-dibromo-2-butyne-1,4-diol, or brominated polyethers.

Antiaging agents can also be added to the coatable compositions of the present invention so as to minimize the effects of oxidation by oxygen, thermal oxidation, hydrolysis, surface yellowing, and the like. Antiaging agents suitable for use herein include sterically hindered phenols and secondary aromatic amines, thioethers, phosphites or phosphines, antioxidants such as 2,6-di-t-butyl-p-cresol or 4,4′-di-t-octyl-diphenylamine, UV absorbers such as benzotriazole or benzophenone derivatives, optical brighteners based on benzoxazole or stilbene derivatives, pyrazolines, carbodiimides, and cyclic acetals, as well as combinations thereof.

Other possible ingredients suitable for inclusion in the coatable compositions of the present invention include defoamers, surfactants, leveling aids, mar and slip additives, air release additives, blowing agents, antioxidants, coloring agents, and optical brighteners.

The UV radiation source preferably emits radiation at wavelengths of from about 290 nm to about 400 nm, and more preferably from about 350 nm to about 400 nm. In one embodiment, the UV radiation source emits UV A radiation from about 350 nm to about 380 nm, and most preferably the UV radiation source emits UV A radiation at about 365 nm. UV lamps are commonly sold in a number of varieties, which are typically classified by their bulb-type. For example, the Fusion “H” bulb is a typical UV light source consisting primarily of an electrical discharge in medium pressure mercury vapor. The Fusion “D” bulb is similar to the “H” bulb, but additionally contains small quantities of one or more metal halides. The “V” bulb also contains a small quantity of one or more metal halides, similar to the “D” bulb, but it emits a larger fraction of its radiant energy at longer wavelengths. Another type of lamp is the mercury lamp containing metal halides, which are typically known as “doped” lamps and contain either “D” or “V” bulbs.

A preferred UV radiation source suitable for curing the radiation-curable polymeric composition of the present invention is a filtered or unfiltered UV A arc lamp, “H bulb”, or “D bulb”. Most preferably, the UV radiation source is operating at about 365 nm and is an “H bulb” or “D bulb” arcless lamp, such as a 300 W per inch to 600 W per inch arcless Mercury Vapor lamp (Fusion UV Systems, Inc., Gaithersburg, Md.). Light intensities can be measured, as necessary, using any number of UV integrating radiometers known in the art.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLE

Examples of wood products and wood veneers prepared in accordance with the processes of the present invention can be evaluated in a variety of manners to establish the performance characteristics of the finished products.

In one testing embodiment, the samples were prepared in sizes between about 2.25 inches wide and between 12 and 16 inches long. Various grain patterns are selected for testing to obtain more representative results. Ten pieces were run. A control specimen, cut from the same sample, which had not undergone treatment in accordance with the present invention was run as a standard in comparison to the wood products treated as discussed above.

The wood samples were heated in an appropriate oven for about 15 hours at about 150° F. The wood samples were then removed from the oven and allowed to cool in ambient temperature conditions for about 2 hours, during which time the heat was allowed to slowly release from the product. The wood samples were then visually checked, and the number of end cracks and body cracks counted for any checks or cracks formed in the finish from the heating and cooling process. As shown in Table 1, the number of cracks were less in the treated samples than in the non-treated samples.

TABLE 1

| | Control | Treated | Control | Treated |
|---|---|---|---|---|
| | # of End | # of End | # of Body | # of Body |
| Sample | Cracks | Cracks | Cracks | Cracks |
| 1 | 14 | 3 | 2 | 0 |
| Light | | | | |
| 2 | 3 | 0 | 0 | 0 |
| Light | | | | |
| 3 | 11 | 1 | 5 | 0 |
| Light | | | | |
| 4 | 6 | 0 | 23 | 0 |
| Light | | | | |
| 5 | 8 | 0 | 11 | 0 |
| Light | | | | |
| 6 | 12 | 6 | 20 | 3 |
| Dark | | | | |
| 7 | 7 | 2 | 19 | 0 |
| Dark | | | | |
| 8 | 7 | 0 | 18 | 0 |
| Dark | | | | |
| 9 | 13 | 1 | 21 | 0 |
| Dark | | | | |
| 10 | 7 | 0 | 21 | 0 |
| Dark | | | | |

All of the compositions, methods and/or processes disclosed and claimed herein can be made and executed without undue experimentation in light of the present disclosure. While the compositions and methods of this invention have been described in terms of preferred embodiments, it will be apparent to those of skill in the art that variations may be applied to the compositions, methods, and/or processes and in the steps or in the sequence of steps of the methods described herein without departing from the concept and scope of the invention. More specifically, it will be apparent that certain agents which are chemically related may be substituted for the agents described herein while the same or similar results would be achieved. All such similar substitutes and modifications apparent to those skilled in the art are deemed to be within the scope and concept of the invention.

What is claimed is:

1. A process for producing a wood product exhibiting enhanced resistance to checking, the process comprising:
selecting a wood component, wherein the wood component has at least a first surface;
heating the first surface of the wood component; and
applying a radiation-curable composition to the first surface of the wood component.

2. The process of claim 1, wherein the wood component is a wood veneer adhered to at least one surface of a core material.

3. The process of claim 1, further comprising a sanding step wherein the first surface of the selected wood component is sanded with one or more abrasives.

4. The process of claim 1, wherein the radiation-curable composition is applied before the heating step.

5. The process of claim 1, further comprising a curing step comprising exposing the wood product to UV A radiation using a UV lamp at a wavelength from about 320 nm to about 400 nm.

6. The process of claim 1 wherein the heating step uses an infrared heat source.

7. The process of claim 1, wherein the heating occurs for a period of time from between about 1 second and about 20 seconds.

8. The process of claim 7, wherein the heating occurs for a period of time from between about 5 seconds and about 10 seconds.

9. The process of claim 1, wherein the board surface temperature of the wood component is heated to a temperature greater than about 200° F.

10. The process of claim 9, wherein the board surface temperature of the wood component is heated to a temperature from between about 210° F. and about 400° F.

11. The process of claim 10, wherein the board surface temperature of the wood component is heated to a temperature from between about 250° F. and about 325° F.

12. The process of claim 1, wherein the infrared heat has an emission power from about 100 w-in⁻¹ to about 200 w-in⁻¹.

13. The process of claim 1, wherein the radiation-curable composition has a solids content greater than about 50% by weight.

14. The process of claim 1, wherein the radiation-curable composition is an acrylic polymeric composition.

15. The process of claim 14, wherein the radiation-curable composition further comprises an initiator selected from the group consisting of thermal initiators, photoinitiators, and combinations thereof in an amount from about 0.1 wt. % to about 10 wt. %.

16. A process for producing a wood product having an exposed surface of wood veneer and wherein the veneer exhibits enhanced resistance to checking, the process comprising:
sanding the exposed surface of the wood veneer with one or more coated abrasives;
heating the exposed surface of the wood veneer for a period of time sufficient to obtain a board surface temperature greater than about 200° F. using an infrared heat source;
applying a radiation-curable composition to the exposed surface of the wood veneer; and
curing the radiation-curable composition by exposing the wood product to UV A radiation using a UV lamp at a wavelength from about 320 nm to about 400 nm.

17. The process of claim 16, further comprising the step of applying a stain over the radiation-curable composition.

18. The process of claim 16, further comprising the step of applying a stain to the exposed surface of the wood before the step of applying the radiation-curable composition.

19. The process of claim 16, further comprising the step of sealing the wood product following the step of curing the radiation-curable composition.

20. The process of claim 19, further comprising:
sanding the wood product following the sealing step; and
applying a top finishing coat to the wood product.
